(19) United States
(12) Patent Application Publication
(10) Pub. No.: US 2006/0007048 A1
(43) Pub. Date: Jan. 12, 2006

(54) Adjustable satellite rod

(76) Inventor: Dana D. Forshey, Caldwell, OH (US)

Correspondence Address: LITMAN LAW OFFICES, LTD, PO BOX 15035, CRYSTAL CITY STATION, ARLINGTON, VA, 22215, US

(21) Appl. No.: 10/883,790

(22) Filed: Jul. 6, 2004

(51) Int. Cl. H01Q 1/08; H01Q 1/32

(52) U.S. Cl. 343/880; 343/711

(57) ABSTRACT

A support assembly for a satellite dish that may be mounted on a truck or an RV. The support assembly includes a telescoping tube that is attached to the existing mirror brackets of the truck or RV. The tube has a bottom surface that is provided with a hook and loop fastener. A plate is mounted on the truck's lower mirror bracket and a hook and loop fastener is disposed on the upper surface of the plate. A plumb bob is suspended on a wire inside the tube. A viewing aperture and cross-hair arrangement in the tube allows a user to determine when the tube is plumb with the vertical axis. The bottom of the tube is secured to the plate via the hook and loop fasteners when in the plumb position. A clamp with a centering collar secures the tube to the upper mirror bracket.

### BACKGROUND OF THE INVENTION

1. Field of the Invention

The present invention generally relates to supports. More specifically, the present invention is drawn to a support and adjusting assembly for mounting a satellite dish on a truck or an RV.

2. Description of the Related Art

Satellite TV has become a very popular utility with campers, tractor-trailer drivers and other constantly mobile persons. To function properly, satellite TV requires an antennae system that usually includes a dish used to coordinate with the satellite. Existing systems require a user to track longitude and latitude or to employ a zip code directory in order to establish proper azimuth and elevation for the dish. For example, when traveling in a particular area, it may be necessary to adjust the dish to an azimuth of 228 degrees with a 43 degrees elevation. This adjustment will coordinate the dish with the satellite. Problems arise, however, if the support for the dish is not precisely vertical or plumb. As currently practiced, the support for the dish is often permanently and rigidly attached to the truck or RV. If the vehicle is parked on uneven terrain, the support rod will not be plumb and a set of coordinates is established that require guesswork and experimentation to find the satellite. The above problem is also shared when the dish is mounted on a structure such as a tripod. The art would certainly welcome a system that would allow a trucker or camper to quickly and easily plumb the support rod for a satellite dish.

There are many patents in the related art that are drawn to structure for mounting antennae to motor vehicles and the like. For example, U.S. Pat. No. 3,984,076 (Van Ordt) and U.S. Pat. No. 4,003,540 (Hawks) disclose structure for mounting antennae supports to vehicles. The supports are permanently attached to the vehicles and there is no attempt to adjust the support to be sure that it is plumb.

U.S. Pat. No. 2,439,061 (Shur) and U.S. Pat. No. 4,605,333 (Hovland et al.) show antennae supported on immovable structure such as a building wall or the roof of a house.

U.S. Pat. No. 5,961,092 (Coffield) is drawn to a dish antennae mounted on a truck. As noted above, the support for the dish is permanently mounted to the truck and there is no means for determining if the support is plumb at any truck position.

None of the above inventions and patents, taken either singly or in combination, is seen to disclose a mounting assembly for a satellite dish as will be subsequently described and claimed in the instant invention. Thus an adjustable satellite rod solving the aforementioned problems is desired.

### SUMMARY OF THE INVENTION

The present invention is a support assembly for a satellite dish hat may be mounted on a truck or an RV. The support assembly comprises a telescoping tube that is removably attached to the existing mirror brackets of the truck or RV. The tube has a bottom surface that is provided with a hook and loop fastener thereon. A solid plate is mounted on the truck's lower mirror bracket and a hook and loop fastener is disposed on the upper surface of the plate. A plumb bob is suspended on a wire inside the tube. A viewing aperture and cross-hair arrangement in the tube allows a user to determine when the tube is precisely aligned (plumb) with the vertical axis. The bottom of the tube is secured to the plate via the hook and loop fasteners when in the plumb position. The dish can now be turned to the desired coordinates for maximum reception. A clamp with a centering collar is used to secure the tube to the upper mirror bracket. As contemplated, the support assembly may also be utilized with other structures such as an anchored tripod.

Accordingly, it is a principal object of the invention to provide a support assembly for mounting a satellite dish to a truck or RV.

It is another object of the invention to provide a support assembly for mounting a satellite dish, which assembly can be easily adjusted relative to azimuth and elevation coordinates.

It is a further object of the invention to provide a support assembly for mounting a satellite dish, which assembly can be easily adjusted to a plumb position.

Still another object of the invention is to provide a support assembly for mounting a satellite dish, which assembly may be utilized with an anchored structure such as a tripod.

It is an object of the invention to provide improved elements and arrangements thereof for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of an adjustable satellite rod assembly according to the present invention.

FIG. 2A is a partial, environmental, perspective view of an adjustable satellite rod assembly according to the present invention.

FIG. 2B is a partial, bottom view of a telescoping tube according to the present invention.

FIG. 3 is a partial, environmental, perspective view of an adjustable satellite rod assembly according to the present invention.

FIG. 4 is a partial, fragmented view illustrating the plumb wire and cross-hair arrangement of an adjustable satellite rod assembly according to the present invention.

FIG. 5 is a partial, perspective view illustrating an adjustable satellite rod assembly mounted on an anchored tripod according to the present invention.

Similar reference characters denote corresponding features consistently throughout the attached drawings.

### DETAILED DESCRIPTION OF THE PREFERRED EMBODIMENT

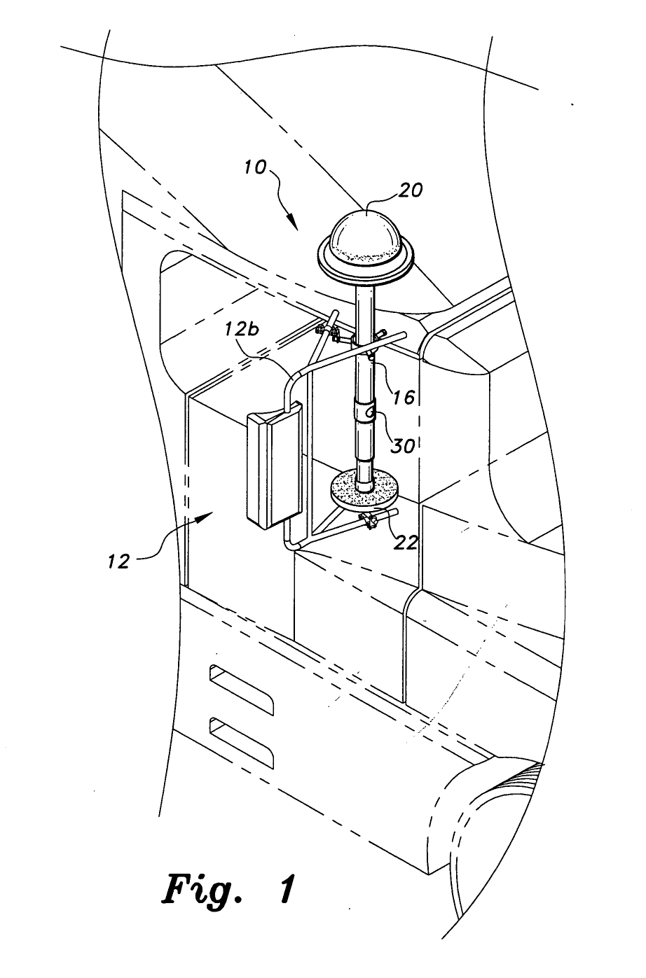

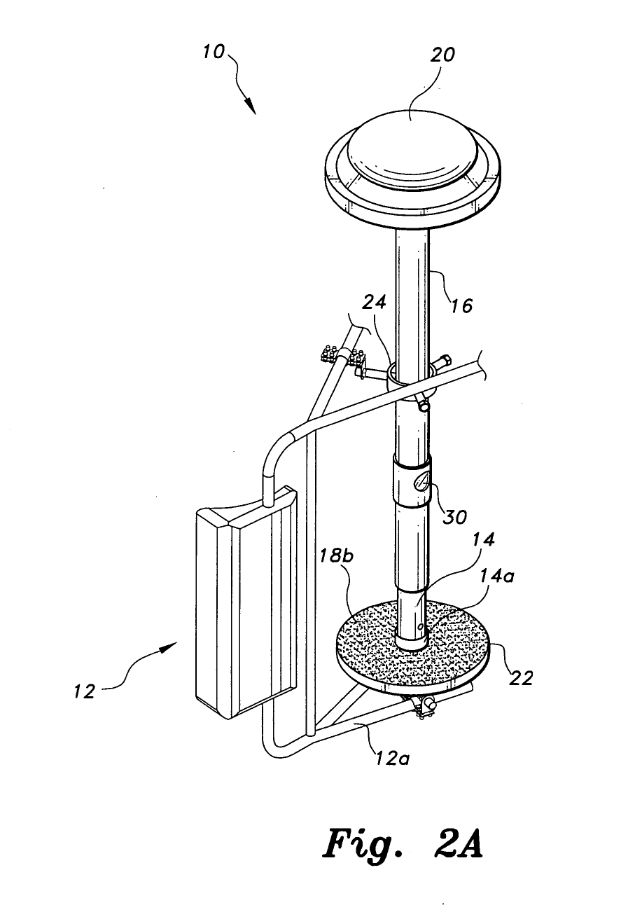

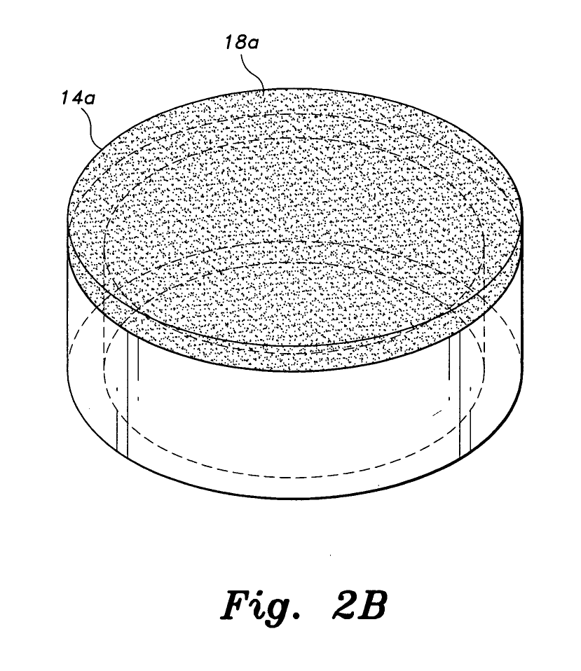

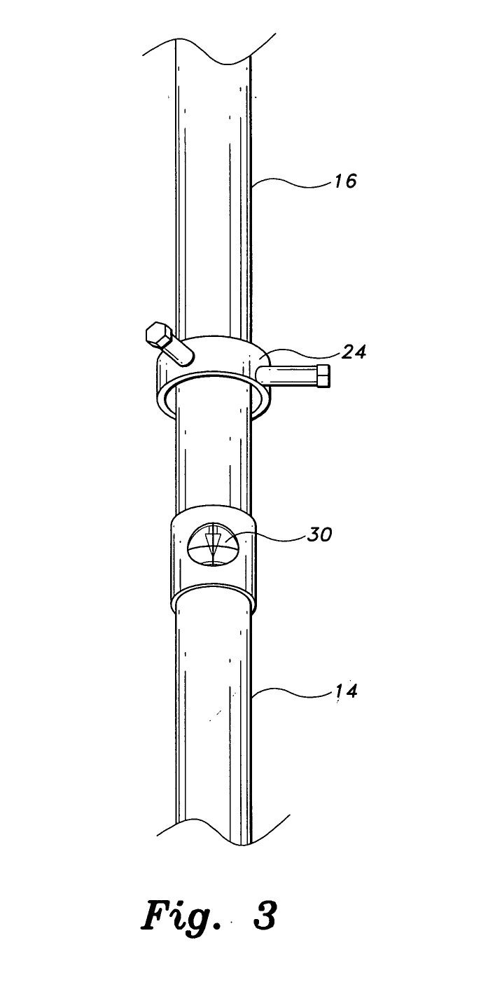

Attention is first directed to FIGS. 1-3 wherein the adjustable satellite assembly of the present invention is generally indicated at 10. Assembly 10 is mounted to the existing mirror support structure 12 of a truck or RV. Assembly 10 includes telescoping hollow tubes 14 and 16. Inner tube 14 is provided with a bottom wall 14a, which wall has a hook and loop fastener 18a disposed thereon. A satellite dish 20 is mounted on the upper end of outer tube 16. A solid plate 22 is positioned on and attached to the lower portion 12a of mirror support structure 12. Plate 22 has a planar upper surface on which surface is disposed a hook and loop fastener 18b. Mounting collar 24 is attached to the outer surface of tube 16 and to the upper portion 12b of mirror support structure 12. Tube 16 is provided with a covered opening 30 for reasons as will be explained below. Plate 22 and collar 24 may be attached to the mirror structure by any conventional means, since the mirror structure may vary on different trucks and RVs.

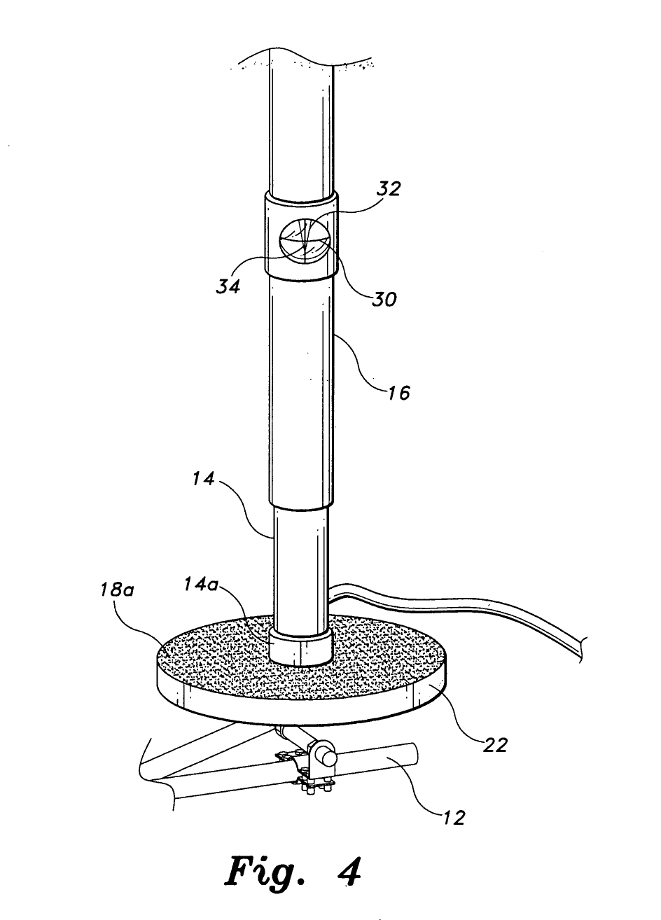

As best seen in FIG. 4, a transparent, shatter-resistant, plastic material is utilized to cover opening 30. A plumb line 32 is suspended within the hollow interior of tube 16. Cross-hairs 34 are mounted in the tube so that plumb alignment may be visually ascertained. It is recognized that other conventional plumb alignment means (bubble tubes) could be employed. The plumb line, however, has proven to be most effective. In use, plumb line 32 is aligned with cross-hairs 34 so that the tubes 14 and 16 are aligned in the vertical axis (plumb). The bottom of tube 14 is attached, via the hook and loop fasteners, to plate 22. Collar 24 is adjusted to maintain the vertical alignment. Tube 16 is then rotated and adjusted up or down so that the dish will be positioned at the proper elevation and azimuth and optimum reception is attained.

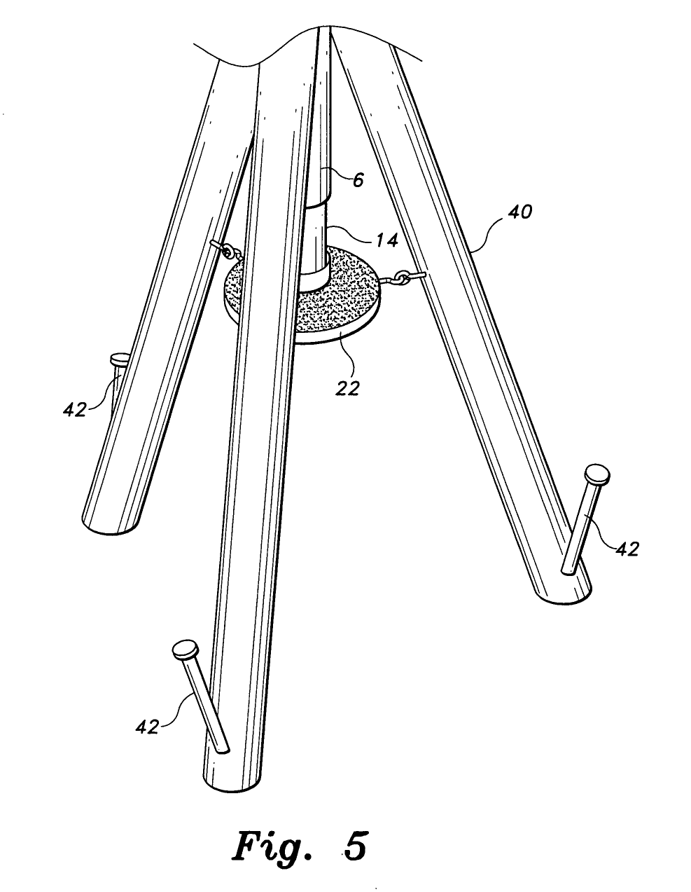

Often it is desired that the satellite assembly be mounted on structure other than a truck. This is especially true if a user is camping. A common mounting structure is a tripod 40 (FIG. 5). Tripod 40 must be securely anchored at 42 to prevent the wind from moving or toppling it. Plate 22 is suspended from the legs of the tripod and the assembly positioned thereon similarly as described above. It is recognized that other mounting structures may be employed.

It is to be understood that the present invention is not limited to the embodiments described above, but encompasses any and all embodiments within the scope of the following claims.

I claim:

1. An adjustable satellite assembly and support structure therefor, comprising:
an outer hollow tube, said outer hollow tube having an upper end;
an inner hollow tube, said inner hollow tube having a bottom wall and telescopically disposed within said outer hollow tube;
a satellite dish, said satellite dish positioned on said upper end of said outer hollow tube;
a device for determining the vertical alignment of said inner hollow tube and said outer hollow tube, said device disposed within said outer hollow tube; and
means for mounting said assembly to said support structure.

2. An adjustable satellite rod assembly and support therefor as recited in claim 1, wherein said means for mounting includes a hook and loop fastener disposed on said bottom wall of said inner hollow tube.

3. An adjustable satellite rod assembly and support therefor as recited in claim 1, wherein said means for mounting includes a plate mounted to said support structure, said plate having a flat planar surface and a hook and loop fastener disposed on said flat planar surface.

4. An adjustable satellite rod assembly and support therefor as recited in claim 1, wherein said means for mounting includes a collar member mounted to said support structure and encircling said outer hollow tube.

5. An adjustable satellite rod assembly and support therefor as recited in claim 1, wherein said device for determining the vertical alignment includes a plumb bob suspended in said outer hollow tube.

6. An adjustable satellite rod assembly and support therefor as recited in claim 5, further including a set of cross-hairs mounted in said outer hollow tube.

7. An adjustable satellite rod assembly and support therefor as recited in claim 6, further including an opening in said outer tube for viewing the plumb bob and set of cross-hairs.

8. An adjustable satellite assembly and support structure therefor, comprising:
an outer hollow tube, said outer hollow tube having an upper end;
an inner hollow tube, said inner hollow tube having a bottom wall and telescopically disposed within said outer hollow tube;
a satellite dish, said satellite dish positioned on said upper end of said outer hollow tube;
a device for determining the vertical alignment of said inner hollow tube and said outer hollow tube, said device disposed within said outer hollow tube; and
a hook and loop fastener disposed on said bottom wall of said inner hollow tube;
a plate mounted to said support structure, said plate having a flat planar surface and a hook and loop fastener disposed on said flat planar surface, wherein said bottom wall of said inner hollow tube is disposed on said flat planar surface of said plate; and
a collar member mounted to said support structure and encircling said outer hollow tube.

9. An adjustable satellite assembly and support structure therefor as recited in claim 8, wherein said device for determining the vertical alignment includes a plumb bob and cross-hair arrangement mounted in said outer hollow tube.

10. An adjustable satellite assembly and support structure therefor as recited in claim 8, further including an opening in said outer tube for viewing the plumb bob and set of cross-hairs.

11. An adjustable satellite assembly and support structure therefor as recited in claim 10, wherein said support structure is a mirror support structure on a truck.

12. An adjustable satellite assembly and support structure therefor as recited in claim 10, wherein said support structure is a tripod.
